(19) United States
(12) Patent Application Publication
(10) Pub. No.: US 2026/0177429 A1
(43) Pub. Date: Jun. 25, 2026

(54) MEASUREMENT DEVICE

(71) Applicant: Yokogawa Electric Corporation, Tokyo (JP)

(72) Inventors: Yasuo Sakamaki, Tokyo (JP); Yumiko Sugiyama, Tokyo (JP); Shigeo Uneme, Tokyo (JP); Saki Kobako, Tokyo (JP)

(73) Assignee: Yokogawa Electric Corporation, Tokyo (JP)

(21) Appl. No.: 19/420,618

(22) Filed: Dec. 15, 2025

(30) Foreign Application Priority Data
Dec. 20, 2024 (JP) 2024-225270

(51) Int. Cl. G01J 3/42; G01N 21/25

(52) U.S. Cl. CPC G01J 3/42; G01N 21/255; G01J 2003/423

(57) ABSTRACT

A measurement device for measuring the state of an object to be measured by absorption spectroscopy includes an irradiator that irradiates the object to be measured with irradiation light, a retroreflective first prism disposed on an opposite side from the irradiator with respect to the object to be measured, a retroreflective second prism disposed on the same side as the irradiator with respect to the object to be measured, a light receiver that receives the irradiation light that has passed through the object to be measured multiple times between the first and second prisms, and a first light guide disposed on the same side as the first prism and configured to guide the irradiation light towards the light receiver. The first and second prisms are not concentric in a first direction, and a plurality of passages for the irradiation light is arranged in two rows along the first direction on an optical surface of each of the first and second prisms.

### CROSS-REFERENCE TO RELATED APPLICATION

The present application claims priority to Japanese Patent Application No. 2024-225270 filed on December 20, 2024, the entire contents of which are incorporated herein by reference.

### TECHNICAL FIELD

The present disclosure relates to a measurement device.

### BACKGROUND

A technique exists for measuring the state of an object to be measured, such as a gas, by using absorption spectroscopy. The state includes the presence or absence, the concentration, and the like of the object to be measured. For example, Patent Literature (PTL) 1 discloses an optical multiple reflection container that is small and low cost, does not require the installation of a cooling mechanism around the mirror, and can increase the number of times laser light is reflected.

### CITATION LIST

### Patent Literature

PTL 1: JP 2019-215211 A

### SUMMARY

A measurement device according to several embodiments is for measuring the state of an object to be measured by absorption spectroscopy and includes an irradiator configured to irradiate the object to be measured with irradiation light, a first prism that is disposed on an opposite side from the irradiator with respect to the object to be measured and is retroreflective, a second prism that is disposed on a same side as the irradiator with respect to the object to be measured and is retroreflective, a light receiver configured to receive the irradiation light that has passed through the object to be measured a plurality of times between the first prism and the second prism, and a first light guide disposed on a same side as the first prism and configured to guide the irradiation light towards the light receiver, wherein the first prism and the second prism are not concentric in a first direction, and a plurality of passages for the irradiation light is arranged in two rows along the first direction on an optical surface of each of the first prism and the second prism.

### BRIEF DESCRIPTION OF THE DRAWINGS

In the accompanying drawings:

FIG. 1 is a schematic diagram illustrating an example configuration of a measurement device according to a first embodiment of the present disclosure;

FIG. 2 is a schematic diagram illustrating an example of a first optical surface of a first prism in FIG. 1;

FIG. 3 is a schematic diagram illustrating an example of a second optical surface of a second prism in FIG. 1;

FIG. 4 is a schematic diagram illustrating an example configuration of the measurement device in FIG. 1 from another side;

FIG. 5 is a schematic diagram corresponding to FIG. 1 and illustrating an example configuration of a measurement device according to a variation of the present disclosure;

FIG. 6 is a schematic diagram corresponding to FIG. 2 and illustrating an example of a first optical surface of a first prism in FIG. 5;

FIG. 7 is a schematic diagram corresponding to FIG. 3 and illustrating an example of a second optical surface of a second prism in FIG. 5;

FIG. 8 is a schematic diagram corresponding to FIG. 4 and illustrating an example configuration of the measurement device in FIG. 5 from another side;

FIG. 9 is a schematic diagram for explaining the effect obtained by the measurement device in FIG. 5;

FIG. 10 is a schematic diagram illustrating an example configuration of a measurement device according to a second embodiment of the present disclosure;

FIG. 11 is a schematic diagram illustrating a first example of a second optical component used in each of the first light guide and the second light guide in FIG. 10;

FIG. 12 is a schematic diagram illustrating a second example of the second optical component used in each of the first light guide and the second light guide in FIG. 10; and

FIG. 13 is a schematic diagram illustrating a third example of the second optical component used in each of the first light guide and the second light guide in FIG. 10.

### DETAILED DESCRIPTION

However, in conventional absorption spectroscopy utilizing multiple reflections, there is room for improvement in characteristics including measurement sensitivity and ease of installation of the measurement device.

It would be helpful to provide a measurement device capable of improving various characteristics in absorption spectroscopy that utilizes multiple reflections.

A measurement device according to several embodiments is for measuring the state of an object to be measured by absorption spectroscopy and includes an irradiator configured to irradiate the object to be measured with irradiation light, a first prism that is disposed on an opposite side from the irradiator with respect to the object to be measured and is retroreflective, a second prism that is disposed on a same side as the irradiator with respect to the object to be measured and is retroreflective, a light receiver configured to receive the irradiation light that has passed through the object to be measured a plurality of times between the first prism and the second prism, and a first light guide disposed on a same side as the first prism and configured to guide the irradiation light towards the light receiver, wherein the first prism and the second prism are not concentric in a first direction, and a plurality of passages for the irradiation light is arranged in two rows along the first direction on an optical surface of each of the first prism and the second prism.

This makes it possible to improve various characteristics in absorption spectroscopy that utilizes multiple reflections. The measurement device includes the light receiver that receives irradiation light that has passed through the object to be measured a plurality of times between the first prism and the second prism, each of which is retroreflective. This enables the measurement device to place a multiple reflection cell configured by the first prism and the second prism relative to the object to be measured, thereby lengthening the optical path length of the irradiation light. Additionally, in the measurement device, the first prism and the second prism are not concentric in the first direction, and the plurality of passages for the irradiation light is arranged in two rows along the first direction on the optical surface of each of the first prism and the second prism. Therefore, the measurement device can further increase the optical path length of the irradiation light on the object to be measured as compared to conventional techniques in which a plurality of passages are arranged in one row along the first direction. The measurement device can therefore double the number of reflections and double the optical path length of the irradiation light without narrowing the beam spacing of the irradiation light, thereby also doubling the measurement sensitivity in measuring the state of the object to be measured. Consequently, the measurement device can also improve the measurement accuracy of the state of the object to be measured.

In the measurement device in one embodiment, the first light guide may include a first optical component configured to direct the irradiation light back towards the second prism. This makes it possible for the measurement device to realize not only an outward path but also a return path as the optical path of the irradiation light in the multiple reflection cell. This also makes it possible to further increase the optical path length of the irradiation light based on the outward path and the return path. The measurement device makes extensive use of the prism surfaces, including the first optical surface and the second optical surface, of the multiple reflection cell formed by the prism, thereby enabling the number of reflections to be further increased. Consequently, the measurement device can further improve the measurement sensitivity and measurement accuracy in measuring the state of the object to be measured.

In the measurement device in one embodiment, the irradiator and the light receiver may be arranged in parallel in a second direction intersecting the first direction on a same side as the second prism. With this configuration, the emission point of irradiation light in the irradiator and the incidence point of irradiation light in the light receiver can be arranged in the measurement device on the same side of the object to be measured, without having to arrange these points on opposite sides of the object to be measured. The light receiver can be arranged on the same side as the irradiator. Therefore, the measurement device can easily arrange each component included in the measurement device relative to the object to be measured, thereby improving ease of installation of the device itself. The measurement device allows the irradiation side and the light receiving side to be integrated into one device, which makes it easy to install the measurement device and also enables a decrease in size.

In the measurement device in one embodiment, the first optical component may be retroreflective. This enables the measurement device to accurately reflect, in the 180 degree direction, the irradiation light that exits the second prism and is incident on the first optical component. For example, the measurement device can accurately direct back, in the negative direction of the z-axis, irradiation light that is incident on the first optical component from the negative direction towards the positive direction of the z-axis. As a result, the measurement device can accurately realize not only the outward path but also the return path as the optical path of the irradiation light in the multiple reflection cell.

In the measurement device in one embodiment, the first optical component may include a right-angle prism. This enables the measurement device to direct the irradiation light accurately back towards the second prism in a state in which the return path of the irradiation light is offset in the second direction from the outward path, for example. Therefore, the measurement device can be configured so that the plurality of passages for the irradiation light are arranged in two rows along the first direction on each optical surface of the prisms, not only on the outward path but also on the return path in the optical path of the irradiation light.

In the measurement device in one embodiment, the first light guide may include a second optical component configured to move an optical path of the irradiation light emitted from the second prism away from the first prism along the first direction. This enables the measurement device to increase the distance between the position at which the irradiation light is incident on the light receiver and the body of the first prism in the prism multiple reflection cell, thereby reducing interference between the light receiver and the first prism. The measurement device allows the irradiation light to propagate in a narrow area and facilitates the arrangement of the light receiver, even when the shift between the first prism and the second prism along the first direction is small. The measurement device can reduce the passage of the irradiation light to an area, outside the measurement area, where the object to be measured is not present, as compared to when, for example, the light receiver is at a position shifted in the positive direction of the z-axis from the first prism without bending the optical path of the irradiation light. This enables the measurement device to reduce error factors in measuring the state of the object to be measured.

In the measurement device in one embodiment, the irradiator may be disposed at a position such that an exit surface of the irradiation light faces the optical surface of the first prism and is flush with the optical surface of the second prism. With this configuration, the irradiator can be arranged in the measurement device so that the exit surface of the irradiation light in the irradiator is in contact with the object to be measured. The measurement device can also irradiate the object to be measured with irradiation light from the irradiator over the shortest distance and cause the irradiation light to be incident on the first optical surface of the first prism along the optical axis of the irradiator over the shortest distance. As a result, the measurement device can reduce factors that cause errors in measuring the state of the object to be measured, which may occur, for example, when the irradiation light emitted from the irradiator passes outside the measurement area to an area where the object to be measured is not present. For example, in a case in which the measurement device measures oxygen concentration, it is thought that the irradiation light may be absorbed by an oxygen gas component that is unrelated to the object being measured, due to oxygen contained in the atmosphere. As a result, an error would occur in the oxygen concentration as the object to be measured. The measurement device is also capable of reducing such errors and improving the measurement accuracy.

The measurement device in one embodiment may further include a second light guide configured to bring an optical path of the irradiation light emitted from the irradiator closer to the second prism along the first direction. This enables the measurement device to increase the distance between the emission position of the irradiation light in the irradiator and the second prism body in the prism multiple reflection cell, thereby reducing interference between the irradiator and the second prism. The measurement device allows the irradiation light to propagate in a narrow area and facilitates the arrangement of the irradiator, even when the shift between the first prism and the second prism along the first direction is small. The measurement device can reduce the passage of the irradiation light to an area, outside the measurement area, where the object to be measured is not present, as compared to when, for example, the irradiator is at a position shifted in the negative direction of the z-axis from the second prism without bending the optical path of the irradiation light. This enables the measurement device to reduce error factors in measuring the state of the object to be measured.

The measurement device in one embodiment may further include a plurality of sets of the first prism and the second prism along the first direction, the first prism and the second prism not being concentric in the first direction, and in each set, a plurality of passages for the irradiation light may be arranged in two rows along the first direction on the optical surface of each of the first prism and the second prism.

This enables the measurement device to increase the number of reflections in the multiple reflection cell, thereby improving the measurement sensitivity by increasing the optical path length. For example, in a case in which the spacing in the x direction of the optical paths of the irradiation light on the object to be measured is the same between one set of prisms and two sets of prisms, the number of optical paths of the irradiation light along the x direction nearly doubles in the two sets of prisms. The measurement device can easily achieve high sensitivity even when, for example, the number of reflections is limited by the beam diameter of the irradiation light in one set of prisms.

In the measurement device in one embodiment, each of the first prism and the second prism may include a corner cube or a right-angle prism. As a result, even if the optical path of the irradiation light becomes long due to repeated multiple reflections in the multiple reflection cell, the retroreflectivity makes the measurement device less susceptible to the effect, on the optical path, of vibration of the multiple reflection cell. The measurement device facilitates adjustment of the number of reflections and adjustment of the optical axis in the multiple reflection cell.

According to the present disclosure, a measurement device capable of improving various characteristics in absorption spectroscopy that utilizes multiple reflections can be provided.

The background and problems with conventional techniques will now be described in more detail.

A method of measuring gas concentration using laser light is a method of measuring the concentration of a substance by measuring the absorbance of irradiated laser light, taking advantage of the property in laser absorption spectroscopy whereby molecules absorb light of a specific wavelength. The absorbance depends on the number of molecules present in the space through which the laser light passes. If the gas density is uniform, the longer the optical path of the laser light, the stronger the signal strength related to absorbance will be. As a result, the accuracy of the absorbance measurement is improved.

In a known measurement method using multiple reflections, a laser beam is made to travel back and forth multiple times within an object to be measured such as a gas, thereby increasing the optical path length. For example, a method using a prism multiple reflection cell is also known as a method of multiple reflection. The method includes positioning two prisms facing each other so that their centerlines in a predetermined direction are offset from each other in the predetermined direction.

In conventional prism multiple reflection cells, when the light traces of multiple reflections are arranged in a row along a specified direction on the optical surface, which is the input/output surface of the prism, the number of reflections is determined based on the prism diameter and the beam diameter of the laser light. On the other hand, to achieve a set number of reflections, the laser light needs to maintain the required beam diameter over the entire optical path length obtained by the multiple reflections.

However, when the optical path length is particularly long, the beam diameter tends to widen due to the phenomenon of optical diffraction. Such a beam diameter expansion becomes more noticeable as the beam diameter of the parallel light becomes smaller. Achieving a long, narrow laser light beam is not easy. Therefore, there is a lower limit to the beam diameter, which is one of the factors that determine the number of reflections. For the above reasons, when the points at which laser light enters and exits are arranged in a row on the optical surface of a prism of finite size, there is a limit on how much the number of reflections can be increased.

Additionally, in a conventional prism multiple reflection cell, the laser light source is disposed on one of the two prisms, and the light receiving element is disposed on the other prism. For this reason, when the measurement area between the prisms becomes long, it is necessary to separate the laser light source and the light receiving element and to place the laser light source and the light receiving element so as to sandwich the measurement area therebetween. As a result, the ease of installation of the measurement device is reduced.

To address these issues, it would be helpful to provide a measurement device capable of improving various characteristics in absorption spectroscopy that utilizes multiple reflections. For example, the present disclosure relates to a prism multiple reflection cell for use in a gas concentration measurement device using laser light.

An embodiment of the present disclosure will be mainly described below with reference to the accompanying drawings. In the following description, the x direction, y direction, and z direction are based on the directions of the arrows in the drawings. The direction of each arrow is consistent between the different drawings. The x direction corresponds to a "first direction" in the claims. The y direction corresponds to the "second direction intersecting the first direction" in the claims. In some figures, the x, y, and z directions are omitted for the sake of simplicity.

### First Embodiment

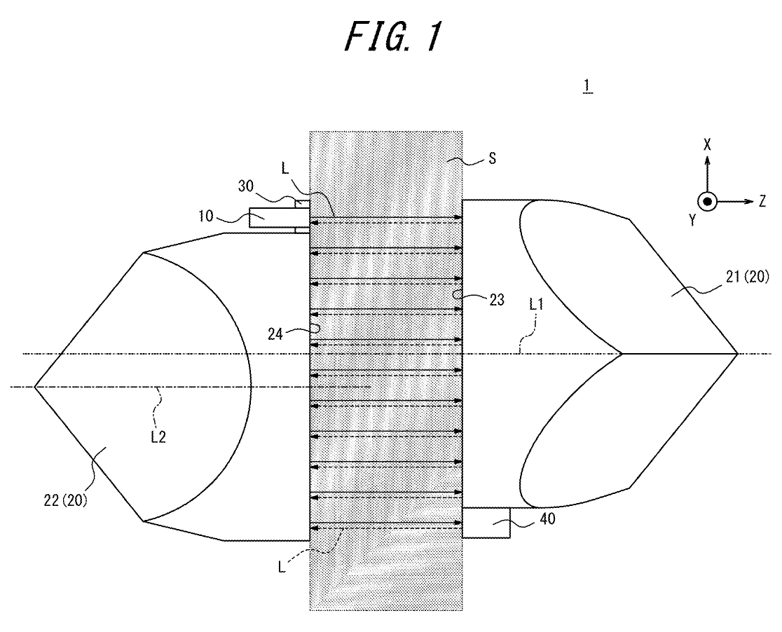

FIG. 1 is a schematic diagram illustrating an example configuration of a measurement device according to a first embodiment of the present disclosure. An example of the configuration and functions of a measurement device 1 according to the first embodiment will be mainly described with reference to FIG. 1.

The measurement device 1 measures the state of the object to be measured S by absorption spectroscopy using a prism multiple reflection cell. In the present disclosure, the "object to be measured S" includes, for example, any object that is to be detected or measured using the measurement device 1. The object to be measured S includes, for example, a gas. The "state of the object to be measured S" includes the presence or absence of the object to be measured S, the concentration of the object to be measured S, and the like. The measurement device 1 has a prism multiple reflection cell disposed so as to sandwich the object to be measured S from both sides, and the irradiation light L is reflected a plurality of times by the prism multiple reflection cell, so as to pass the irradiation light L through the object to be measured S a plurality of times. The measurement device 1 increases the number of reflections of the irradiation light L in the prism multiple reflection cell as compared to conventional techniques, thereby lengthening the optical path length of the irradiation light L relative to the object to be measured S and improving the measurement sensitivity.

The measurement device 1 includes an irradiator 10, a plurality of prisms 20 including a first prism 21 and a second prism 22, a light receiver 30, and a first light guide 40.

The irradiator 10 has a light source including a laser such as a semiconductor laser. Without being limited thereto, the light source of the irradiator 10 may be, for example, a lamp light source or an LED (Light-Emitting Diode) light source. The irradiator 10 irradiates the object to be measured S with irradiation light L. The irradiator 10 irradiates irradiation light L towards a space including an area in which the object to be measured S exists, via, for example, any optical system included in the irradiator 10. The irradiator 10 is disposed at a position such that the exit surface of the irradiation light L faces a first optical surface 23, described later, of the first prism 21 and such that the irradiator 10 is flush with a second optical surface 24, described later, of the second prism 22.

The object to be measured S exists, for example, in the space between the first prism 21 and the second prism 22. The wavelength of the irradiation light L irradiated by the irradiator 10 is included in the light absorption band of the object to be measured S. In the present disclosure, the "light absorption band" includes any wavelength range, such as a wavelength range in the visible or infrared range. The wavelength of the irradiation light L irradiated by the irradiator 10 includes a wavelength that is absorbed by the object to be measured S.

The first prism 21 is disposed on the opposite side from the irradiator 10 with respect to the object to be measured S and is retroreflective. In the present disclosure, "retroreflectivity" refers to, for example, the property of reflecting light in a direction 180 degrees from the direction of incidence, regardless of the direction from which the light is incident. The first prism 21 includes, for example, a corner cube or a right-angle prism. In FIG. 1 the first prism 21 is illustrated as a corner cube as an example. The corner cube that is the first prism 21 is a prism whose tip portion is cut into three flat surfaces. The corner cube that is the first prism 21 may be made of glass.

The first prism 21 has a first optical surface 23 facing the irradiator 10 and the second prism 22. An end portion of the first optical surface 23 in the positive direction of the x-axis faces, in the z direction, the exit surface of the irradiation light L in the irradiator 10, with the object to be measured S sandwiched therebetween. The first optical surface 23 guides the irradiation light L that is irradiated from the irradiator 10 and passes through the object to be measured S into the interior of the first prism 21. The first optical surface 23 emits the irradiation light L that has been reflected a plurality of times inside the first prism 21 towards the object to be measured S and guides the light through the object to be measured S to the second prism 22 or the light receiver 30.

The second prism 22 is disposed on the same side as the irradiator 10 with respect to the object to be measured S and is retroreflective. The second prism 22 includes, for example, a corner cube or a right-angle prism. In FIG. 1 the second prism 22 is illustrated as a corner cube as an example. The corner cube that is the second prism 22 is a prism whose tip portion is cut into three flat surfaces. The corner cube that is the second prism 22 may be made of glass.

The second prism 22 has a second optical surface 24 facing the first prism 21 and the first light guide 40. An end of the second optical surface 24 in the negative direction of the x-axis faces the first light guide 40 in the z direction, with the object to be measured S sandwiched therebetween. The second optical surface 24 guides the irradiation light L that is emitted from the first prism 21 and passes through the object to be measured S into the interior of the second prism 22. The second optical surface 24 guides the irradiation light L that is directed back by the first light guide 40 and passes through the object to be measured S into the interior of the second prism 22. The second optical surface 24 emits the irradiation light L that has been reflected a plurality of times inside the second prism 22 towards the object to be measured S and guides the light through the object to be measured S to the first prism 21 or the first light guide 40.

The light receiver 30 has a photodetector including a light receiving element such as a photodiode. The light receiver 30 receives the irradiation light L irradiated onto the object to be measured S by the irradiator 10. The light receiver 30 receives the irradiation light L that has passed through the object to be measured S between the first prism 21 and the second prism 22 a plurality of times. At least a part of the wavelength band that can be received by the light receiver 30 is included in the light absorption band of the object to be measured S. The photodetector included in the light receiver 30 has detection sensitivity at the wavelength of the irradiation light L.

The measurement device 1 may calculate the absorbance of the irradiation light L from the intensity of the irradiation light L received by the light receiver 30. The measurement device 1 may calculate the concentration of the object to be measured S from the absorbance of the irradiation light L. The light receiver 30 may be included in the measurement device 1 or may be connected to a calculation device different from the measurement device 1. The calculation device may calculate the absorbance of the irradiation light L and the concentration of the object to be measured S based on the received light signal, corresponding to the intensity of the irradiation light L, outputted from the light receiver 30. The calculation device may be, for example, a dedicated computer, a general-purpose PC (Personal Computer), a server, or the like.

The first light guide 40 is disposed on the same side as the first prism 21 and guides the irradiation light L towards the light receiver 30. The first light guide 40 includes, for example, a first optical component that directs the irradiation light L back towards the second prism 22. The first optical component is, for example, retroreflective. The first optical component includes, for example, a right-angle prism. The first light guide 40 directs the irradiation light L, incident from the negative direction towards the positive direction of the z-axis, back towards the negative direction of the z-axis using the first optical component.

The first prism 21 and the second prism 22 are not concentric in the first direction. For example, a center line L1 of the first prism 21 in the first direction and a center line L2 of the second prism 22 in the first direction do not coincide with each other but are shifted from each other along the first direction. As an example, the center line L1 and the center line L2 are parallel to each other along the z direction. That is, the first optical surface 23 of the first prism 21 and the second optical surface 24 of the second prism 22 may face each other in the z direction so as to be parallel to each other along the xy directions.

The object to be measured S is interposed between a first prism 21 and a second prism 22 which face each other in the z direction. The first optical surface 23 of the first prism 21 may be, for example, parallel to the xy plane. The second optical surface 24 of the second prism 22 may be, for example, parallel to the xy plane. Each of the first optical surface 23 and the second optical surface 24 may be in contact with the object to be measured S.

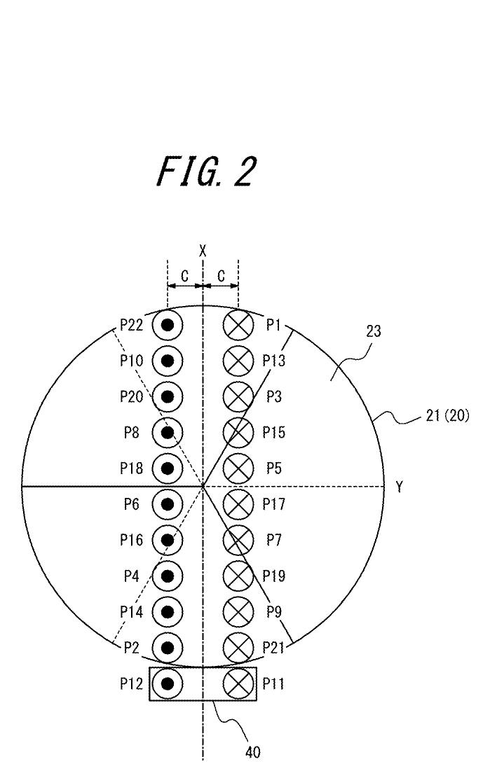

FIG. 2 is a schematic diagram illustrating an example of the first optical surface 23 of the first prism 21 in FIG. 1. An example of the arrangement of a plurality of passages for the irradiation light L on the first optical surface 23 will be mainly described with reference to FIG. 2.

The first optical surface 23 has, for example, a circular shape in the xy plane. On the first optical surface 23 of the first prism 21, the plurality of passages for the irradiation light L are arranged in two rows along the first direction. For example, a plurality of first passages for the irradiation light L are spaced a distance C from the center line of the first optical surface 23 in the y direction to one side in the y direction. The plurality of first passages include passages P1, P3, P5, P7, P9, P13, P15, P17, P19, and P21. The plurality of second passages for the irradiation light L are spaced a distance C away from the center line of the first optical surface 23 in the y direction to the other side in the y direction. The plurality of second passages include passages P2, P4, P6, P8, P10, P14, P16, P18, P20, and P22.

The irradiation light L passing through the first optical surface 23 of the first prism 21 on a multiple reflection optical path is multiply reflected alternately in two rows centered on the x-axis in the order of the passages P1, P2, P3, P4, P5, P6, P7, P8, P9, and P10. For example, the irradiation light L irradiated from the irradiator 10 onto the object to be measured S first enters the interior of the first prism 21 through the passage P1. The irradiation light L is repeatedly reflected inside the first prism 21 and is emitted towards the object to be measured S from the passage P2. The irradiation light L reflected by the second prism 22 enters the interior of the first prism 21 again through the passage P3.

Similarly, the irradiation light L that enters the interior of the first prism 21 from the passage P3 exits from the passage P4. The irradiation light L that enters the interior of the first prism 21 from the passage P5 exits from the passage P6. The irradiation light L that enters the interior of the first prism 21 from the passage P7 exits from the passage P8. The irradiation light L that enters the interior of the first prism 21 from the passage P9 exits from the passage P10.

The irradiation light L exiting from the passage P10 to the object to be measured S and reflected by the second prism 22 enters the interior of the first light guide 40 from the passage P11 of the first light guide 40. The irradiation light L is repeatedly reflected and directed back inside the first light guide 40 and is emitted towards the object to be measured S from the passage P12. At this time, the irradiation light L exits from the first light guide 40 at the passage P12, which is twice the distance C away in the y direction from the position of incidence on the first light guide 40 at the passage P11.

The irradiation light L directed back by the first light guide 40 repeats multiple reflections in the order of passages P12, P13, P14, P15, P16, P17, P18, P19, P20, P21, and P22, so as to fill the spaces between the passages P1, P2, P3, P4, P5, P6, P7, P8, P9, P10, and P11, which are the outward path. For example, the irradiation light L that is emitted from the first light guide 40 at the passage P12 and is reflected by the second prism 22 enters the interior of the first prism 21 from the passage P13. The irradiation light L is repeatedly reflected inside the first prism 21 and is emitted towards the object to be measured S from the passage P14. The irradiation light L reflected by the second prism 22 enters the interior of the first prism 21 again through the passage P15.

Similarly, the irradiation light L that enters the interior of the first prism 21 from the passage P15 exits from the passage P16. The irradiation light L that enters the interior of the first prism 21 from the passage P17 exits from the passage P18. The irradiation light L that enters the interior of the first prism 21 from the passage P19 exits from the passage P20. The irradiation light L that enters the interior of the first prism 21 from the passage P21 exits from the passage P22. The irradiation light L emitted from the passage P22, which is a distance C away from the x-axis, passes through the object to be measured S and is incident on the light receiver 30.

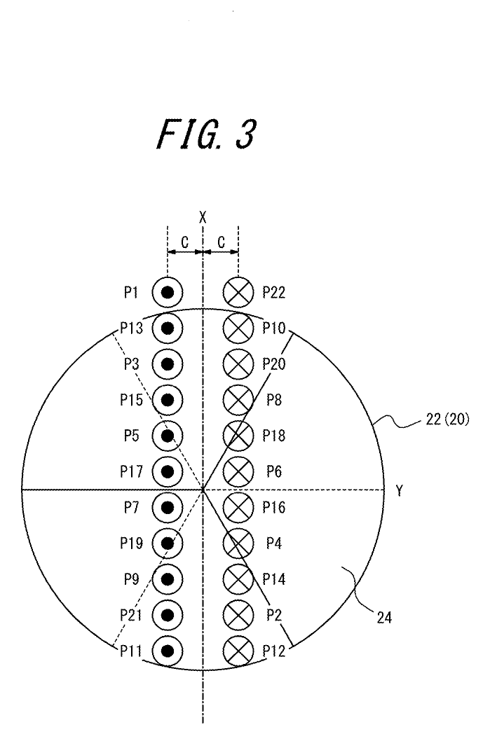

FIG. 3 is a schematic diagram illustrating an example of the second optical surface 24 of the second prism 22 in FIG. 1. An example of the arrangement of a plurality of passages for the irradiation light L on the second optical surface 24 will be mainly described with reference to FIG. 3.

The second optical surface 24 has, for example, a circular shape in the xy plane. On the second optical surface 24 of the second prism 22, the plurality of passages for the irradiation light L are arranged in two rows along the first direction. For example, a plurality of third passages for the irradiation light L are spaced a distance C from the center line of the second optical surface 24 in the y direction to one side in the y direction. The plurality of third passages include passages P2, P4, P6, P8, P10, P12, P14, P16, P18, and P20. The plurality of fourth passages for the irradiation light L are spaced a distance C away from the center line of the second optical surface 24 in the y direction to the other side in the y direction. The plurality of fourth passages include passages P3, P5, P7, P9, P11, P13, P15, P17, P19, and P21.

The irradiation light L passing through the second optical surface 24 of the second prism 22 on a multiple reflection optical path is multiply reflected alternately in two rows centered on the x-axis in the order of the passages P2, P3, P4, P5, P6, P7, P8, P9, P10, and P11. For example, the irradiation light L emitted from the irradiator 10, passing through the passage P1, and reflected by the first prism 21 first enters the interior of the second prism 22 from the passage P2. The irradiation light L is repeatedly reflected inside the second prism 22 and is emitted towards the object to be measured S from the passage P3. The irradiation light L reflected by the first prism 21 enters the interior of the second prism 22 again through the passage P4.

Similarly, the irradiation light L that enters the interior of the second prism 22 from the passage P4 exits from the passage P5. The irradiation light L that enters the interior of the second prism 22 from the passage P6 exits from the passage P7. The irradiation light L that enters the interior of the second prism 22 from the passage P8 exits from the passage P9. The irradiation light L that enters the interior of the second prism 22 from the passage P10 exits from the passage P11.

The irradiation light L that is emitted from the passage P11 to the object to be measured S and is directed back by the first light guide 40 repeats multiple reflections in the order of passages P12, P13, P14, P15, P16, P17, P18, P19, P20, P21, and P22, so as to fill the spaces between the passages P1, P2, P3, P4, P5, P6, P7, P8, P9, P10, and P11, which are the outward path. For example, the irradiation light L emitted from the first light guide 40 enters the interior of the second prism 22 from the passage P12. The irradiation light L is repeatedly reflected inside the second prism 22 and is emitted towards the object to be measured S from the passage P13. The irradiation light L reflected by the first prism 21 enters the interior of the second prism 22 again through the passage P14.

Similarly, the irradiation light L that enters the interior of the second prism 22 from the passage P14 exits from the passage P15. The irradiation light L that enters the interior of the second prism 22 from the passage P16 exits from the passage P17. The irradiation light L that enters the interior of the second prism 22 from the passage P18 exits from the passage P19. The irradiation light L that enters the interior of the second prism 22 from the passage P20 exits from the passage P21. The irradiation light L that is emitted from the passage P21 and reflected by the first prism 21 passes through the passage P22 and is incident on the light receiver 30.

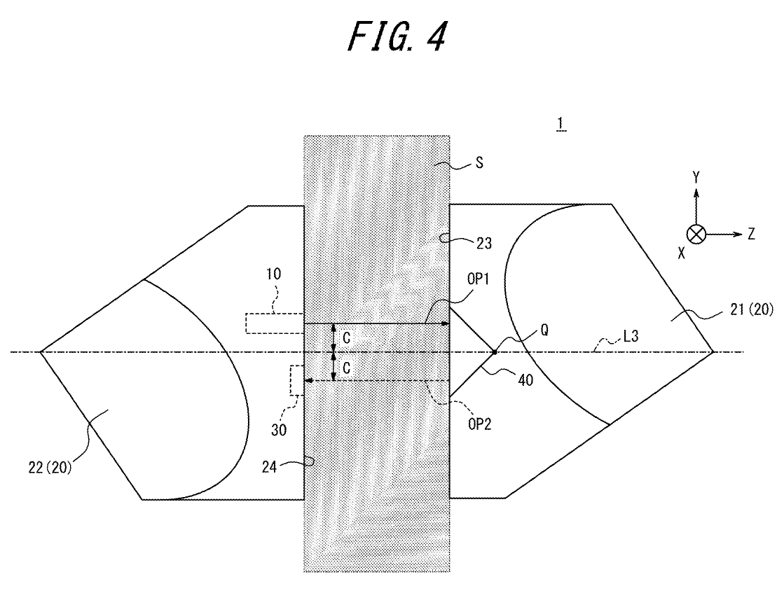

FIG. 4 is a schematic diagram illustrating an example configuration of the measurement device in FIG. 1 from another side. An example of the configuration of the measurement device 1 in FIG. 1 on another side will be mainly described with reference to FIG. 4.

The light receiver 30, together with the irradiator 10, are arranged in parallel in a second direction intersecting the first direction on the same side as the second prism 22. The apex Q of the right-angle prism serving as the first light guide 40 and the central axis L3 of the prism 20 parallel to the z direction are located in the same xz plane perpendicular to the y direction. That is, in the side view of FIG. 4, the apex Q of the right-angle prism is located on the central axis L3 of the prism 20 that is parallel to the z direction.

In FIG. 4, a plurality of first optical paths OP1 of the irradiation light L passing through the inside of the object to be measured S, which are respectively arranged between plurality of first passages in the first prism 21 and plurality of fourth passages in the second prism 22, overlap in the x direction at a distance C on one side of the y direction with respect to the central axis L3. Similarly, a plurality of second optical paths OP2 of the irradiation light L passing through the inside of the object to be measured S, which are respectively arranged between plurality of second passages in the first prism 21 and plurality of third passages in the second prism 22, overlap in the x direction at a distance C on the other side of the y direction with respect to the central axis L3.

According to the measurement device 1 of the embodiment described above, various characteristics in absorption spectroscopy using multiple reflections can be improved. The measurement device 1 includes the light receiver 30 that receives irradiation light L that has passed through the object to be measured S a plurality of times between the first prism 21 and the second prism 22, each of which is retroreflective. This enables the measurement device 1 to place a multiple reflection cell configured by the first prism 21 and the second prism 22 relative to the object to be measured S, thereby lengthening the optical path length of the irradiation light L. Additionally, in the measurement device 1, the first prism 21 and the second prism 22 are not concentric in the first direction, and the plurality of passages for the irradiation light L is arranged in two rows along the first direction on the optical surface of each of the first prism 21 and the second prism 22. Therefore, the measurement device 1 can further increase the optical path length of the irradiation light L on the object to be measured S as compared to conventional techniques in which a plurality of passages are arranged in one row along the first direction. The measurement device 1 can therefore double the number of reflections and double the optical path length of the irradiation light L without narrowing the beam spacing of the irradiation light L, thereby also doubling the measurement sensitivity in measuring the state of the object to be measured S. Consequently, the measurement device 1 can also improve the measurement accuracy of the state of the object to be measured S.

In the measurement device 1, the first light guide 40 includes the first optical component that directs the irradiation light L back towards the second prism 22. This makes it possible for the measurement device 1 to realize not only an outward path but also a return path as the optical path of the irradiation light L in the multiple reflection cell. This also makes it possible to further increase the optical path length of the irradiation light L based on the outward path and the return path. The measurement device 1 makes extensive use of the prism surfaces, including the first optical surface 23 and the second optical surface 24, of the multiple reflection cell formed by the prism 20, thereby enabling the number of reflections to be further increased. Consequently, the measurement device 1 can further improve the measurement sensitivity and measurement accuracy in measuring the state of the object to be measured S.

In the measurement device 1, the irradiator 10 and the light receiver 30 are arranged in parallel in a second direction intersecting the first direction on the same side as the second prism 22. With this configuration, the emission point of irradiation light L in the irradiator 10 and the incidence point of irradiation light L in the light receiver 30 can be arranged in the measurement device 1 on the same side of the object to be measured, without having to arrange these points on opposite sides of the object to be measured S. The light receiver 30 can be arranged on the same side as the irradiator 10. Therefore, the measurement device 1 can easily arrange each component included in the measurement device 1 relative to the object to be measured S, thereby improving ease of installation of the device itself. The measurement device 1 allows the irradiation side and the light receiving side to be integrated into one device, which makes it easy to install the measurement device 1 and also enables a decrease in size.

The first optical component of the first light guide 40 is retroreflective. This enables the measurement device 1 to accurately reflect, in the 180 degree direction, the irradiation light L that exits the second prism 22 and is incident on the first optical component. For example, the measurement device 1 can accurately direct back, in the negative direction of the z-axis, irradiation light L that is incident on the first optical component from the negative direction towards the positive direction of the z-axis. As a result, the measurement device 1 can accurately realize not only the outward path but also the return path as the optical path of the irradiation light L in the multiple reflection cell.

The first optical component of the first light guide 40 includes a right-angle prism. This enables the measurement device 1 to direct the irradiation light L accurately back towards the second prism 22 in a state in which the return path of the irradiation light L is offset in the second direction from the outward path, for example. Therefore, the measurement device 1 can be configured so that the plurality of passages for the irradiation light L are arranged in two rows along the first direction on each optical surface of the prisms 20, not only on the outward path but also on the return path in the optical path of the irradiation light L.

The irradiator 10 is disposed at a position such that the exit surface of the irradiation light L faces the first optical surface 23 of the first prism 21 and such that the irradiator 10 is flush with the second optical surface 24 of the second prism 22. With this configuration, the irradiator 10 can be arranged in the measurement device 1 so that the exit surface of the irradiation light L in the irradiator 10 is in contact with the object to be measured S. The measurement device 1 can also irradiate the object to be measured S with irradiation light L from the irradiator 10 over the shortest distance and cause the irradiation light L to be incident on the first optical surface 23 of the first prism 21 along the optical axis of the irradiator 10 over the shortest distance. As a result, the measurement device 1 can reduce factors that cause errors in measuring the state of the object to be measured S, which may occur, for example, when the irradiation light L emitted from the irradiator 10 passes outside the measurement area to an area where the object to be measured S is not present. For example, in a case in which the measurement device 1 measures oxygen concentration, it is thought that the irradiation light L may be absorbed by an oxygen gas component that is unrelated to the object to be measured S, due to oxygen contained in the atmosphere. As a result, an error would occur in the oxygen concentration as the object to be measured S. The measurement device 1 is also capable of reducing such errors and improving the measurement accuracy.

Each of the first prism 21 and the second prism 22 includes a corner cube or a right-angle prism. As a result, even if the optical path of the irradiation light L becomes long due to repeated multiple reflections in the multiple reflection cell, the retroreflectivity makes the measurement device 1 less susceptible to the effect, on the optical path, of vibration of the multiple reflection cell. The measurement device 1 facilitates adjustment of the number of reflections and adjustment of the optical axis in the multiple reflection cell.

In the first embodiment, the irradiator 10 and the light receiver 30 have been described as being arranged in parallel in the second direction intersecting the first direction on the same side as the second prism 22, but this configuration is not limiting. The irradiator 10 and the light receiver 30 do not have to be arranged in parallel in the second direction on the same side as the second prism 22. Also, the irradiator 10 and the light receiver 30 do not have to be arranged on the same side as each other, as illustrated in the arrangement in the second embodiment, described below.

In the first embodiment, the first optical component of the first light guide 40 has been described as being retroreflective, but this configuration is not limiting. The first optical component need not be retroreflective.

In the first embodiment, the first optical component of the first light guide 40 has been described as including a right-angle prism, but this configuration is not limiting. The first optical component may include any other component capable of realizing the function of directing back the irradiation light L. For example, the first optical component may include a retroreflective corner cube.

In the first embodiment, the irradiator 10 has been described as being disposed at a position such that the exit surface of the irradiation light L faces the first optical surface 23 of the first prism 21 and such that the irradiator 10 is flush with the second optical surface 24 of the second prism 22, but this configuration is not limiting. As described in the second embodiment below, the irradiator 10 may be disposed at a position such that the exit surface of the irradiation light L is shifted in the first direction from the first optical surface 23 of the first prism 21 and does not face the first optical surface 23. The irradiator 10 need not be disposed at a position that is flush with the second optical surface 24 of the second prism 22. For example, if it is difficult to accommodate the irradiator 10 in the gap shifted in the first direction between the first prism 21 and the second prism 22, the irradiator 10 may be disposed at a position shifted in the negative direction of the z-axis from a position flush with the second optical surface 24.

In the first embodiment, each of the first prism 21 and the second prism 22 has been described as including a corner cube or a right-angle prism, but this configuration is not limiting. Each of the first prism 21 and the second prism 22 may include any other retroreflective prism. The first prism 21 and the second prism 22 may be the same type of prism, as in the first embodiment, or may be different types of prisms.

In the first embodiment, on the first optical surface 23 of the first prism 21, the passages P1, P3, P5, P7, P9, P11, P13, P15, P17, P19, and P21 are arranged in a row along the first direction on the same straight line, but this configuration is not limiting. The passages P1, P3, P5, P7, P9, P11, P13, P15, P17, P19, and P21 may be arranged in a row along the first direction at positions offset from one another relative to the same straight line.

In the first embodiment, on the first optical surface 23 of the first prism 21, the passages P2, P4, P6, P8, P10, P12, P14, P16, P18, P20, and P22 are arranged in a row along the first direction on the same straight line, but this configuration is not limiting. The passages P2, P4, P6, P8, P10, P12, P14, P16, P18, P20, and P22 may be arranged in a row along the first direction at positions offset from one another relative to the same straight line.

In the first embodiment, on the second optical surface 24 of the second prism 22, the passages P1, P3, P5, P7, P9, P11, P13, P15, P17, P19, and P21 are arranged in a row along the first direction on the same straight line, but this configuration is not limiting. The passages P1, P3, P5, P7, P9, P11, P13, P15, P17, P19, and P21 may be arranged in a row along the first direction at positions offset from one another relative to the same straight line.

In the first embodiment, on the second optical surface 24 of the second prism 22, the passages P2, P4, P6, P8, P10, P12, P14, P16, P18, P20, and P22 are arranged in a row along the first direction on the same straight line, but this configuration is not limiting. The passages P2, P4, P6, P8, P10, P12, P14, P16, P18, P20, and P22 may be arranged in a row along the first direction at positions offset from one another relative to the same straight line.

In the first embodiment, the first optical surface 23 of the first prism 21 and the second optical surface 24 of the second prism 22 have been described as facing each other in the z direction so as to be parallel to each other along the xy directions, but this configuration is not limiting. The first optical surface 23 of the first prism 21 and the second optical surface 24 of the second prism 22 may face each other in the z direction so as to be non-parallel to each other along at least one of the x and y directions. In other words, the first prism 21 and the second prism 22 may face each other in an inclined state. This makes it possible for the measurement device 1 to reduce the influence of returning light occurring at the first optical surface 23 or the second optical surface 24.

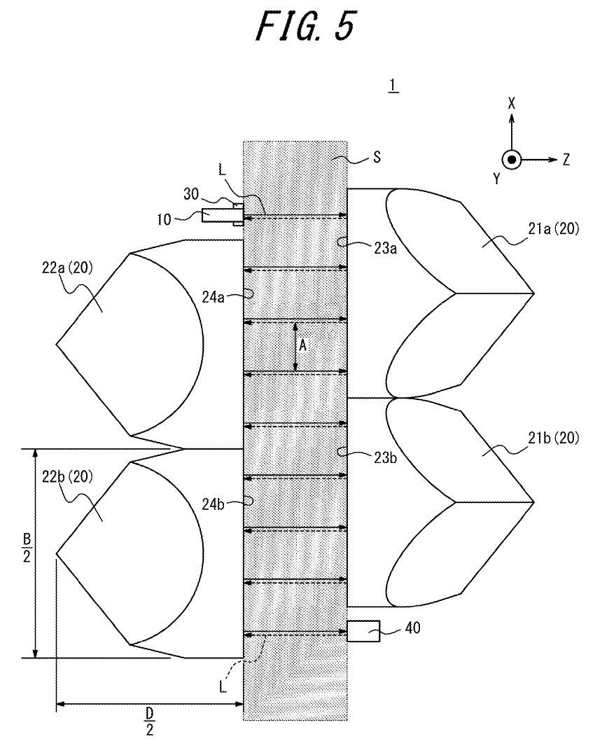

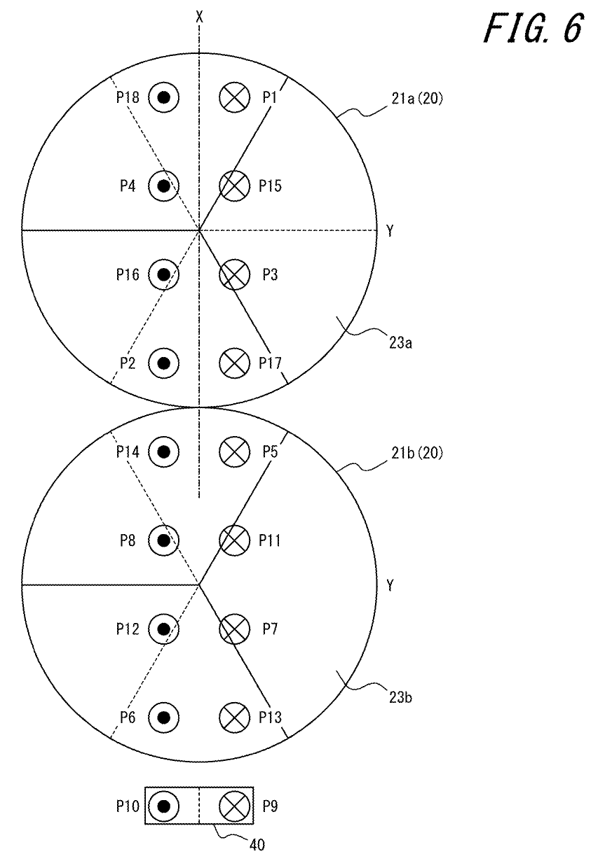

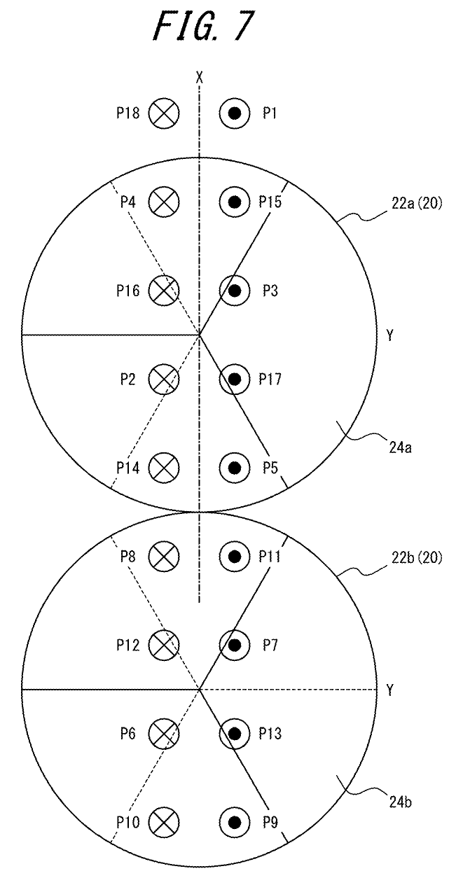

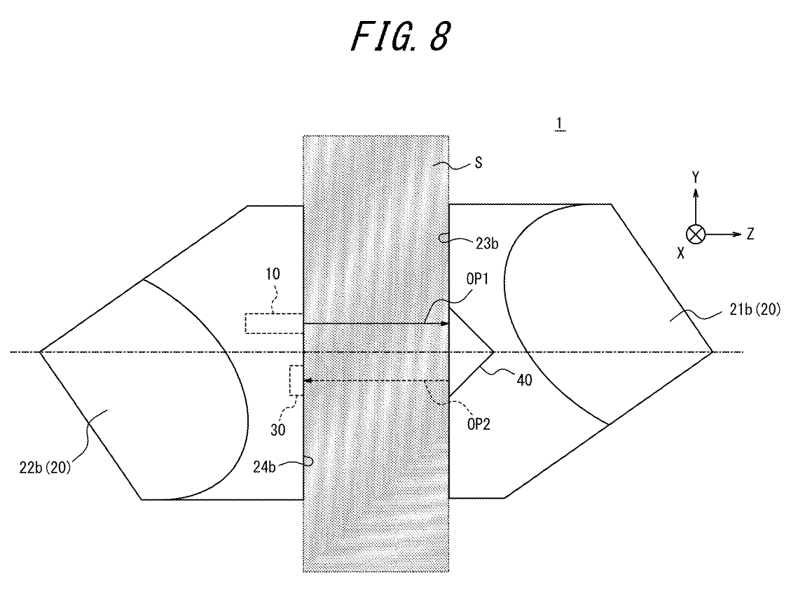

FIG. 5 is a schematic diagram corresponding to FIG. 1 and illustrating an example configuration of a measurement device 1 according to a variation of the present disclosure. FIG. 6 is a schematic diagram corresponding to FIG. 2 and illustrating an example of first optical surfaces 23a, 23b of first prisms 21a, 21b in FIG. 5. FIG. 7 is a schematic diagram corresponding to FIG. 3 and illustrating an example of second optical surfaces 24a, 24b of second prisms 22a, 22b in FIG. 5. FIG. 8 is a schematic diagram corresponding to FIG. 4 and illustrating an example configuration of the measurement device in FIG. 5 from another side. An example of the configuration and functions of the measurement device 1 according to the variation will be mainly described with reference to FIGS. 5-8.

In the above first embodiment, the prism 20 includes one set of the first prism 21 and the second prism 22, but this configuration is not limiting. The measurement device 1 may include a plurality of sets of the first prism 21 and the second prism 22 along the first direction, the first prism 21 and the second prism 22 not being concentric in the first direction. For example, the measurement device 1 may have a configuration in which a set of the first prism 21a and the second prism 22a and a set of the first prism 21b and the second prism 22b are arranged in order from the positive side to the negative side in the x direction. As illustrated in FIGS. 6 and 7, in each set, the first prism 21 and the second prism 22 may have a plurality of passages for the irradiation light L arranged in two rows along the first direction on each optical surface.

For example, a plurality of first passages may be arranged on the first optical surface 23a of the first prism 21a. The plurality of first passages may include passages P1, P3, P15, and P17. For example, a plurality of first passages may be arranged on the first optical surface 23b of the first prism 21b. The plurality of first passages may include passages P5, P7, P11, and P13.

For example, a plurality of second passages may be arranged on the first optical surface 23a of the first prism 21a. The plurality of second passages may include passages P2, P4, P16, and P18. For example, a plurality of second passages may be arranged on the first optical surface 23b of the first prism 21b. The plurality of second passages may include passages P6, P8, P12, and P14.

For example, a plurality of third passages may be arranged on the second optical surface 24a of the second prism 22a. The plurality of third passages may include passages P2, P4, P14, and P16. For example, a plurality of third passages may be arranged on the second optical surface 24b of the second prism 22b. The plurality of third passages may include passages P6, P8, P10, and P12.

For example, a plurality of fourth passages may be arranged on the second optical surface 24a of the second prism 22a. The plurality of fourth passages may include passages P3, P5, P15, and P17. For example, a plurality of fourth passages may be arranged on the second optical surface 24b of the second prism 22b. The plurality of fourth passages may include passages P7, P9, P11, and P13.

The measurement device 1 according to the above variation can increase the number of reflections in the multiple reflection cell, thereby improving the measurement sensitivity by increasing the optical path length. For example, in a case in which the spacing A in the x direction of the optical paths of the irradiation light L on the object to be measured S is the same between one set of prisms 20 and two sets of prisms 20, the number of optical paths of the irradiation light L along the x direction nearly doubles in the two sets of prisms 20. The measurement device 1 can easily achieve high sensitivity even when, for example, the number of reflections is limited by the beam diameter of the irradiation light L in one set of prisms 20.

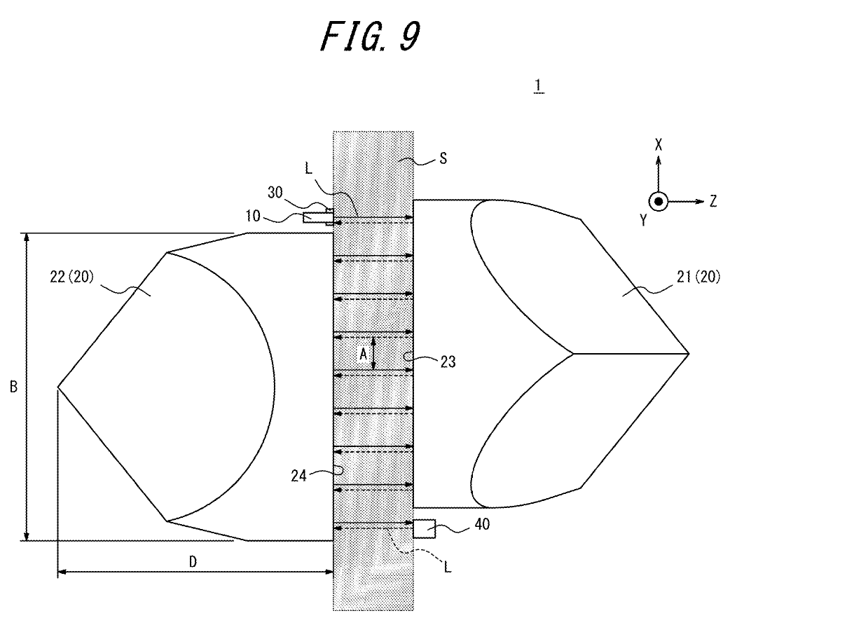

In addition, the volume of the prisms 20 in the measurement device 1 can be reduced, making it possible to achieve a smaller size and lighter weight. FIG. 9 is a schematic diagram for explaining the effect obtained by the measurement device 1 of FIG. 5. FIG. 9 corresponds to FIG. 5. For example, when one prism 20 is taken into consideration, the width along the x direction in FIG. 9 is width B, whereas the width along the x direction in FIG. 5 is width B/2. Similarly, when one prism 20 is considered, the width along the z direction in FIG. 9 is width D, whereas the width along the z direction in FIG. 5 is width D/2.

Therefore, if the same number of reflections is achieved by one set of prisms 20 as illustrated in FIG. 9 and two sets of prisms 20 as illustrated in FIG. 5, the volume of one prism 20 will be 1/4 of the volume of the two sets of prisms 20. Therefore, the multiple reflection cell of the measurement device 1 can be made small, and the weight of a heavy prism 20 made of glass material can be reduced.

The measurement device 1 is also capable of reducing the attenuation of the amount of the irradiation light L. For example, when the same number of reflections is achieved by one set of prisms 20 as illustrated in FIG. 9 and two sets of prisms 20 as illustrated in FIG. 5, the single prism 20 is reduced in size in the configuration with two sets of prisms 20 as described above, and therefore the optical path length of the irradiation light L passing through the inside of the glass of the prism 20 is shortened. Therefore, the amount of attenuation of the irradiation light L due to the attenuation rate of the glass material is improved.

### Second Embodiment

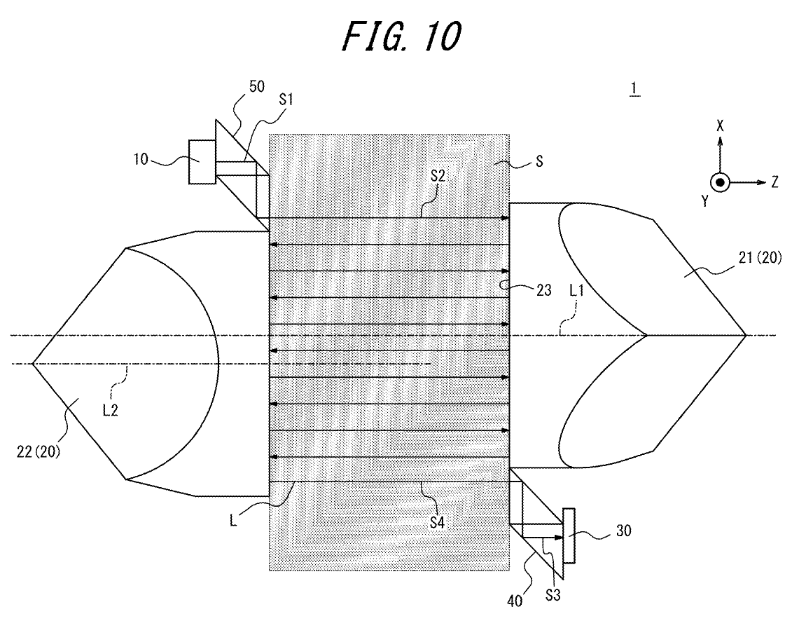

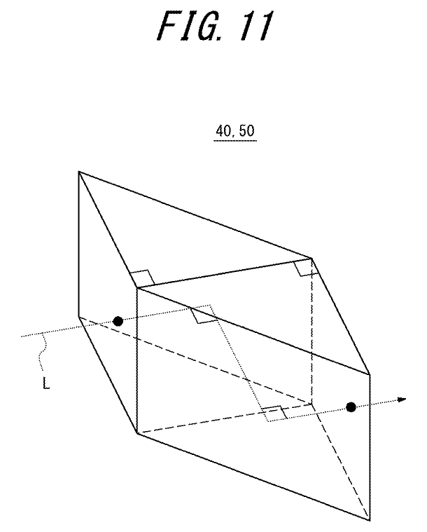

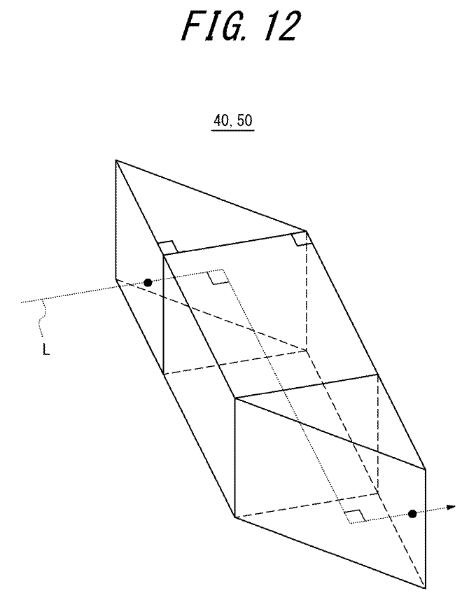

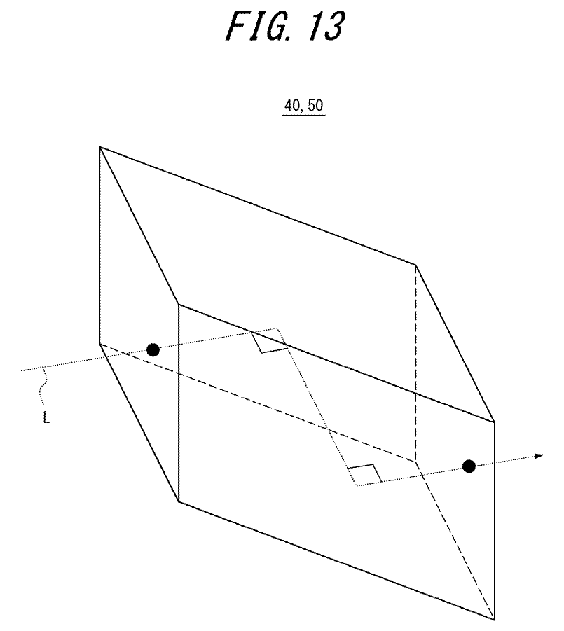

FIG. 10 is a schematic diagram illustrating an example configuration of a measurement device 1 according to a second embodiment of the present disclosure. FIG. 11 is a schematic diagram illustrating a first example of the second optical component used in each of the first light guide 40 and the second light guide 50 in FIG. 10. FIG. 12 is a schematic diagram illustrating a second example of the second optical component used in each of the first light guide 40 and the second light guide 50 in FIG. 10. FIG. 13 is a schematic diagram illustrating a third example of the second optical component used in each of the first light guide 40 and the second light guide 50 in FIG. 10. An example of the configuration and functions of a measurement device 1 according to the second embodiment will be mainly described with reference to FIGS. 10 and 13.

The measurement device 1 according to the second embodiment of the present disclosure differs from the first embodiment in that the first light guide 40 has a function to offset light instead of a function to direct light back with respect to the optical path of the irradiation light L. Other configurations, functions, effects, variations, and the like are similar to those of the first embodiment, and the corresponding explanations also apply to the measurement device 1 according to the second embodiment. In the following, components similar to those in the first embodiment are given the same reference numerals, and a description thereof is omitted. The differences from the first embodiment are mainly described.

In the first embodiment, the first light guide 40 has been described as including the first optical component that directs the irradiation light L back towards the second prism 22, but this configuration is not limiting. Instead of the first optical component, the first light guide 40 may include a second optical component that moves the optical path of the irradiation light L emitted from the second prism 22 away from the first prism 21 along the first direction. In addition, the measurement device 1 may further include a second light guide 50 that brings the optical path of the irradiation light L emitted from the irradiator 10 closer to the second prism 22 along the first direction. The second light guide 50 may include a second optical component of the same type as that of the first light guide 40 or may include a second optical component of a different type.

For example, as illustrated in FIG. 11, the second optical component included in each of the first light guide 40 and the second light guide 50 may be a component in which a pair of right-angle prisms are combined. For example, as illustrated in FIG. 12, the second optical component included in each of the first light guide 40 and the second light guide 50 may be a component in which a hexahedral glass material is further disposed between a pair of right-angle prisms. For example, as illustrated in FIG. 13, the second optical component included in each of the first light guide 40 and the second light guide 50 may be a rhomboid prism.

The second optical component may, for example, shift the first optical path S1, which is the optical path immediately after the irradiation light L is emitted from the irradiator 10, in the positive direction of the x-axis from the second optical path S2, which is the optical path by which the irradiation light L is incident on the first prism 21 at the end in the positive direction of the x-axis. The second optical component bends the optical path of the irradiation light L emitted from the irradiator 10 twice at an angle of 90 degrees by a pair of parallel inclined surfaces. The second optical component thereby provides a gap along the first direction between the first optical path S1 and the second optical path S2.

The second optical component, for example, shifts the third optical path S3, which is the optical path immediately before the irradiation light L is incident on the light receiver 30, in the negative direction of the x-axis from the fourth optical path S4, which is the optical path by which the irradiation light L exits from the second prism 22 at the end in the negative direction of the x-axis. The second optical component bends the optical path of the irradiation light L incident on the light receiver 30 twice at an angle of 90 degrees by a pair of parallel inclined surfaces. The second optical component thereby provides a gap along the first direction between the third optical path S3 and the fourth optical path S4.

By the first light guide 40 including the second optical component, the measurement device 1 can increase the distance between the position at which the irradiation light L is incident on the light receiver 30 and the first prism 21 body in the prism multiple reflection cell, thereby reducing interference between the light receiver 30 and the first prism 21. The measurement device 1 allows the irradiation light L to propagate in a narrow area and facilitates the arrangement of the light receiver 30, even when the shift between the first prism 21 and the second prism 22 along the first direction is small. The measurement device 1 can reduce the passage of the irradiation light L to an area, outside the measurement area, where the object to be measured S is not present, as compared to when, for example, the light receiver 30 is at a position shifted in the positive direction of the z-axis from the first prism 21 without bending the optical path of the irradiation light L. This enables the measurement device 1 to reduce error factors in measuring the state of the object to be measured S.

By including the second light guide 50, the measurement device 1 can increase the distance between the emission position of the irradiation light L in the irradiator 10 and the body of the second prism 22 in the prism multiple reflection cell, thereby reducing interference between the irradiator 10 and the second prism 22. The measurement device 1 allows the irradiation light L to propagate in a narrow area and facilitates the arrangement of the irradiator 10, even when the shift between the first prism 21 and the second prism 22 along the first direction is small. The measurement device 1 can reduce the passage of the irradiation light L to an area, outside the measurement area, where the object to be measured S is not present, as compared to when, for example, the irradiator 10 is at a position shifted in the negative direction of the z-axis from the second prism 22 without bending the optical path of the irradiation light L. This enables the measurement device 1 to reduce error factors in measuring the state of the object to be measured S.

It will be apparent to those skilled in the art that the present disclosure may be realized in certain forms other than the above-described embodiments without departing from the spirit or essential characteristics of the present disclosure. Accordingly, the foregoing description is merely illustrative and is not limiting. The scope of the disclosure is defined by the appended claims, not by the foregoing description. Among all modifications, those within a range of equivalents to the present disclosure shall be considered as being included in the present disclosure.

For example, the shape, pattern, size, arrangement, orientation, type, and number of each component described above are not limited to those illustrated in the above description and the drawings. The shape, pattern, size, arrangement, orientation, type, and number of each component may be configured in any way that can achieve the corresponding function. Each component of the illustrated measurement device 1 is a functional concept. The specific form of each component is not limited to that illustrated in the drawings.

Examples of some embodiments of the present disclosure are described below. However, it should be noted that the embodiments of the present disclosure are not limited to these examples.

### Appendix 1

A measurement device for measuring a state of an object to be measured by absorption spectroscopy, the measurement device comprising:

an irradiator configured to irradiate the object to be measured with irradiation light;

a first prism that is disposed on an opposite side from the irradiator with respect to the object to be measured and is retroreflective;

a second prism that is disposed on a same side as the irradiator with respect to the object to be measured and is retroreflective;

a light receiver configured to receive the irradiation light that has passed through the object to be measured a plurality of times between the first prism and the second prism; and

a first light guide disposed on a same side as the first prism and configured to guide the irradiation light towards the light receiver, wherein

the first prism and the second prism are not concentric in a first direction, and a plurality of passages for the irradiation light is arranged in two rows along the first direction on an optical surface of each of the first prism and the second prism.

### Appendix 2

The measurement device according to appendix 1, wherein the first light guide includes a first optical component configured to direct the irradiation light back towards the second prism.

### Appendix 3

The measurement device according to appendix 2, wherein the irradiator and the light receiver are arranged in parallel in a second direction intersecting the first direction on a same side as the second prism.

### Appendix 4

The measurement device according to appendix 2 or 3, wherein the first optical component is retroreflective.

### Appendix 5

The measurement device according to appendix 4, wherein the first optical component includes a right-angle prism.

### Appendix 6

The measurement device according to appendix 1, wherein the first light guide includes a second optical component configured to move an optical path of the irradiation light emitted from the second prism away from the first prism along the first direction.

### Appendix 7

The measurement device according to any one of claims 1-6, wherein the irradiator is disposed at a position such that an exit surface of the irradiation light faces the optical surface of the first prism and is flush with the optical surface of the second prism.

### Appendix 8

The measurement device according to any one of claims 1-6, further comprising a second light guide configured to bring an optical path of the irradiation light emitted from the irradiator closer to the second prism along the first direction.

### Appendix 9

The measurement device according to any one of claims 1-8, further comprising

a plurality of sets of the first prism and the second prism along the first direction, the first prism and the second prism not being concentric in the first direction, wherein

in each set, a plurality of passages for the irradiation light is arranged in two rows along the first direction on the optical surface of each of the first prism and the second prism.

### Appendix 10

The measurement device according to any one of claims 1-9, wherein each of the first prism and the second prism includes a corner cube or a right-angle prism.

1. A measurement device for measuring a state of an object to be measured by absorption spectroscopy, the measurement device comprising:
an irradiator configured to irradiate the object to be measured with irradiation light;
a first prism that is disposed on an opposite side from the irradiator with respect to the object to be measured and is retroreflective;
a second prism that is disposed on a same side as the irradiator with respect to the object to be measured and is retroreflective;
a light receiver configured to receive the irradiation light that has passed through the object to be measured a plurality of times between the first prism and the second prism; and
a first light guide disposed on a same side as the first prism and configured to guide the irradiation light towards the light receiver, wherein
the first prism and the second prism are not concentric in a first direction, and a plurality of passages for the irradiation light is arranged in two rows along the first direction on an optical surface of each of the first prism and the second prism.

2. The measurement device according to claim 1, wherein the first light guide includes a first optical component configured to direct the irradiation light back towards the second prism.

3. The measurement device according to claim 2, wherein the irradiator and the light receiver are arranged in parallel in a second direction intersecting the first direction on a same side as the second prism.

4. The measurement device according to claim 2, wherein the first optical component is retroreflective.

5. The measurement device according to claim 4, wherein the first optical component includes a right angle prism.

6. The measurement device according to claim 1, wherein the first light guide includes a second optical component configured to move an optical path of the irradiation light emitted from the second prism away from the first prism along the first direction.

7. The measurement device according to claim 1, wherein the irradiator is disposed at a position such that an exit surface of the irradiation light faces the optical surface of the first prism and is flush with the optical surface of the second prism.

8. The measurement device according to claim 1, further comprising a second light guide configured to bring an optical path of the irradiation light emitted from the irradiator closer to the second prism along the first direction.

9. The measurement device according to claim 1, further comprising
a plurality of sets of the first prism and the second prism along the first direction, the first prism and the second prism not being concentric in the first direction, wherein
in each set, a plurality of passages for the irradiation light is arranged in two rows along the first direction on the optical surface of each of the first prism and the second prism.

10. The measurement device according to claim 1, wherein each of the first prism and the second prism includes a corner cube or a right angle prism.
